(19) United States
(12) Patent Application Publication
(10) Pub. No.: US 2004/0154380 A1
(43) Pub. Date: Aug. 12, 2004

(54) Method and apparatus for leak detection and location

(76) Inventor: Ian C. Walker, Gloucestershire (GB)

Correspondence Address: Schlumberger Technology Corporation, Schlumberger Reservoir Completions, Patent Counsel, PO Box 1590, Rosharon, TX, 77583-1590, US

(21) Appl. No.: 10/475,376

(22) PCT Filed: Apr. 12, 2002
(86) PCT No.: PCT/GB02/01727

(30) Foreign Application Priority Data
Apr. 26, 2001 (GB) 0110223.5

(51) Int. Cl. G01M 3/12; G01M 3/14; G01M 3/38

(52) U.S. Cl. 73/40.5 R; 73/49.2

(57) ABSTRACT

Leaks are detected by wrapping a vessel such as a pipe 10 or tank 28 in a skin 14 14A 30 which traps escaping fluid 12 at least long enough to direct it, in the vicinity of the leak, towards a sensor line 16 employing fibre optics to detect the fact of a leak and to detect how far along the a fibre optic line the leak exists. The skin 14 14A 30 can be longitudinally applied or wrapped onto the vessel 10 28. Bindings 24 can be used to attach the skin 14 14A 30 to the outside of the vessel 10 28. Sensor line 16 couplings 26 can be employed between lengths of pipe 10 to create monitored sections of pipe 10 which can be joined togther. Sensor lines 16 can be applied to the outer surface of a vessel 10 28 and covered with the skin 14 14A 30. Sensor lines 16 can be stuck or woven into the skin 14 14A 30. The skin 14 14A 30 incorporates elastic ridges 18 18A 18C which face the vessel and direct escaping fluid towards the sensor line 16. A control system 46 40 48 44 is provided to shut down a tank 28 or pipeline 36 38, at least in the vicinity of a leak, if a leak is detected, and can include shutting down pumps 40, closing valves, and voiding items 10 28 subject to the leak.

The present invention relates to a method and apparatus for detecting leaks. The invention particularly relates to detecting fluid (liquid or gaseous) leaks in vessels such as pipelines and storage tanks.

Pipelines are vessels used for conducting fluids, such as gas, water, chemicals or oil, from geographical place to geographical place, or, in an industrial setting, between tanks, between processes, or between processes and tanks and vice versa. Tanks are vessels used for temporary or permanent bulk storage, where the fluid enjoys at least a temporary period of non-movement. There is often a need to detect whether or not a pipe or tank is leaking. Often, this is done by visual inspection, by which time any damage done by the escaping fluid has already occurred, or is done by flow measurements where it is noted that the ingress of fluid volume or quantity is greater than the egress of fluid volume or quantity. In a tank, a leak becomes apparent either by inspection or by noting that the content of the tank has decreased over the sum of its inflow and outflow. The prior art is silent upon any method which will detect a leak, as it occurs anywhere in the system or tank under surveillance. The prior art is also silent upon any method automatically to locate the position of a leak as it occurs.

The present invention seeks to provide a method and apparatus for the rapid detection of the occurrence of a leak anywhere in a vessel or system of vessels under surveillance and the rapid determination of the location of the leak. The present invention also seeks to provide a method and apparatus whereby a leak; anywhere in a system of vessels under surveillance, can be shut down at the moment of detection.

According to a first aspect, the present invention consists in an apparatus for determining the occasion and location of a fluid leak in a vessel, said apparatus comprising: a sensor line, on the outside of the vessel, for detecting where, along the length of the sensor line the sensor line is in contact with the fluid; and a skin, for use on the outside of the vessel and operative to direct leaked fluid towards the sensor line in the vicinity of any leak.

According to a second aspect, the present invention consists in a method for determining the occasion and location of a fluid leak in a vessel, said method including the steps of: disposing a sensor line, on the outside of the vessel, for detecting where, along the length of the sensor line the sensor line is in contact with the fluid; disposing a skin on the outside of the vessel; and employing said skin to direct leaked fluid towards the sensor line in the vicinity of any leak.

The invention further provides that the said skin is operative, at least temporarily, to contain fluid, leaked from the vessel.

The invention further provides that the skin is operative to enclose both the vessel and the sensor line.

The invention further provides that the vessel can be a pipe, that the sensor line is disposable longitudinally along the pipe, that the skin comprises elastic ridges, to be pressed against the outer surface of the pipe, that the elastic ridges are operative to inhibit fluid flow in a longitudinal direction along the outside of the pipe, and that the elastic ridges are operative to direct fluid flow on the outside of the pipe in a circumferential direction towards the sensor line.

The invention further provides that the skin can be disposed longitudinally along the outside of the pipe and can be closed, longitudinally, by means of a securing cover

The invention further provides that the skin can be helically wrapped about the pipe.

The invention further provides that the skin can be further fixed onto the outside of the pipe by means of spaced bands.

The invention further provides that the vessel can be a tank, that the sensor line can be disposed on the outer surface of the tank, that the skin can comprise elastic ridges, to be pressed against the outer surface of the tank, that the elastic ridges can be operative to form containment zones to contain and accumulate fluid from any leak for the fluid to come into contact with the sensor line.

The invention further provides that the skin can be wrapped around the outside of the tank in a close helix, that the skin can comprise partial containment zones, and that a partial containment zone in one coil of the helix can co-operate with a partial containment zone in an adjacent coil of the helix to contain and accumulate fluid from any leak for the fluid to come into contact with the sensor line.

The invention further provides that the sensor line can be incorporated into the fabric of the face of the skin which is for presentation to the outside surface of the vessel.

The invention further provides that the sensor line can be a fibre optic line.

The invention is further explained, by way of example, by the following description, in conjunction with the appended drawings, in which:

FIG. 1 shows a cross sectional view of a vessel in the form of a pipe to which the present invention has been applied.

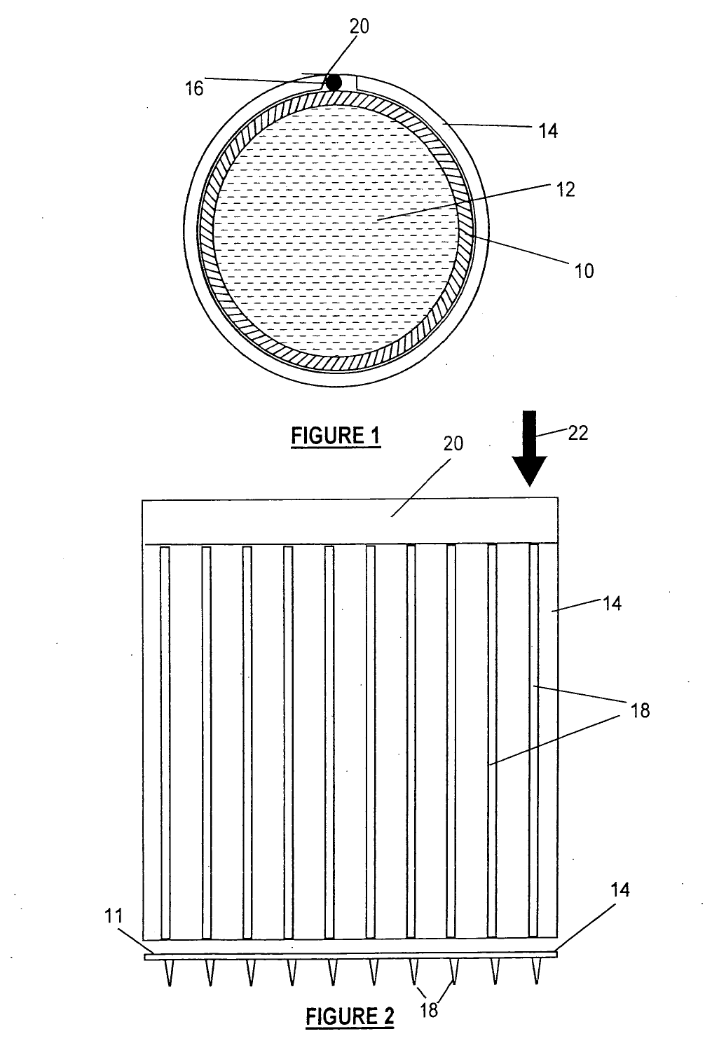

FIG. 2 shows an opened out view of the skin enclosing the pipe of FIG. 1.

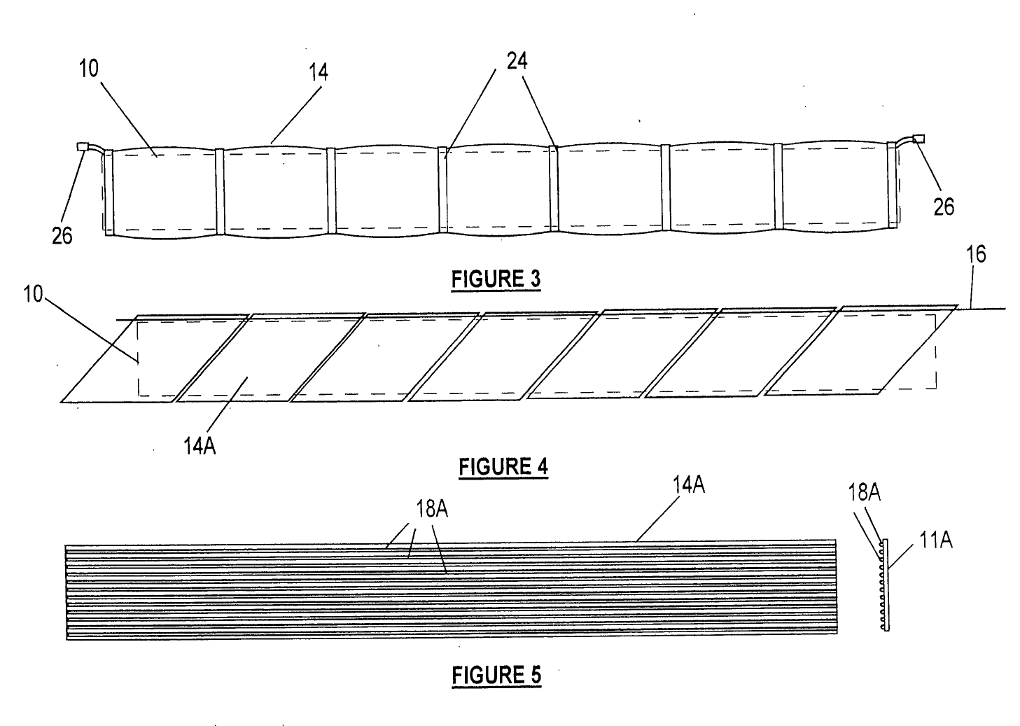

FIG. 3 shows one way of attaching the skin, of FIGS. 1 & 2, to a pipe.

FIG. 4 shows another way that a skin may be applied to a pipe.

FIG. 5 is an example of the skin, which can be used in FIG. 4.

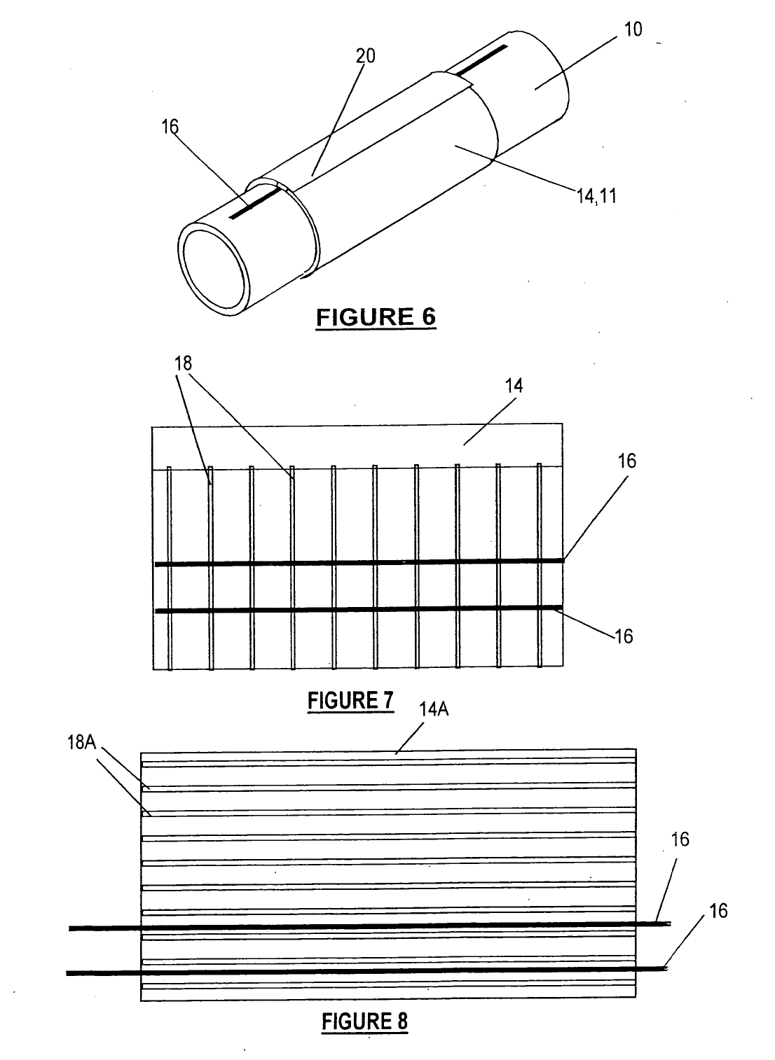

FIG. 6 is an angled view of the pipe, shown in FIG. 1.

FIG. 7 illustrates how sensor lines may be incorporated into the skin otherwise shown in FIG. 2.

FIG. 8 is an example of how sensor lines may be incorporated into the skin, otherwise shown in FIG. 5.

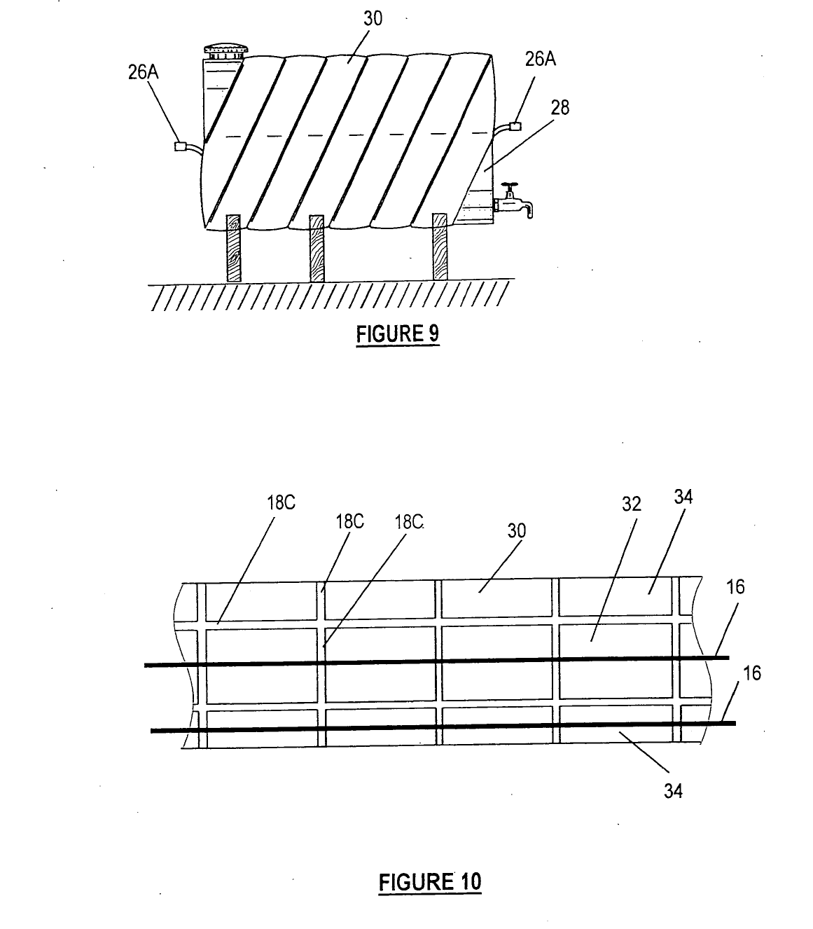

FIG. 9 is a drawing of a vessel in the form of a tank showing how a skin may be applied thereto, not only to detect a leak, but to determine at what part of the tank the leak is occurring.

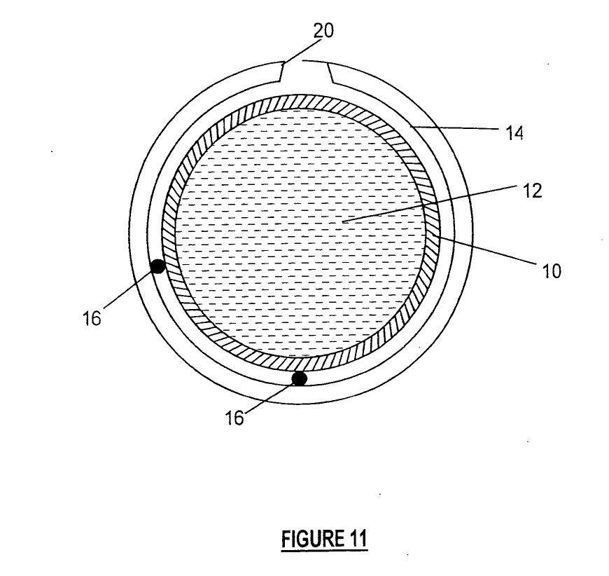

FIG. 10 is a view of the ridge structure of a skin suitable for use on the Lank of FIG. 9, and showing how sensor lines may be applied thereto.

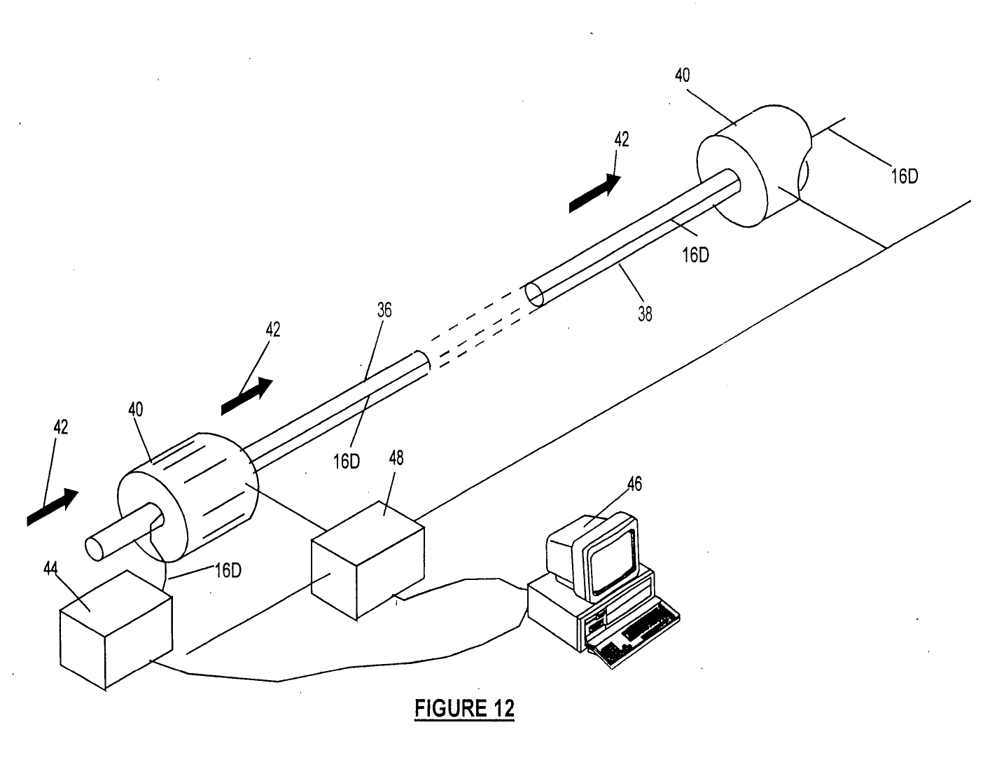

FIG. 11 is a cross sectional view of a pipeline showing how sensor lines can be attached other than at the top of a pipe and how the skin need not provide containment of leaking fluid, merely direction toward the sensor line. And

FIG. 12 is a projected schematic view of an exemplary pumping system, according to the present invention, showing a control system suitable for monitoring a pipeline for leaks, for shutting down the pipeline when a leak is detected, and for providing rapid indication of the location of the leak.

Attention is drawn to FIG. 1. A pipe 10, carrying a fluid load 12, is surrounded by a containment skin 14. Within the containment skin 14, and on top of the pipe 10, a sensor line 16 is provided.

The fluid load 12 can be gaseous or liquid. It can consist of chemical gases, fuel gases, hydrocarbons, oil, water, food stuffs such as milk, chemical liquids and, indeed, just about any type of thing that can be driven along a pipe 10.

Part of the purpose of the skin 14 is to protect the sensor line 16 when the pipe 10 is buried in the ground, encased in concrete, or otherwise exposed to a harsh surrounding environment. Another purpose of the containment skin 14 is, at least temporarily, to contain any of the fluid load 12 which may escape from the pipe 10 at least long enough to duct the escaping fluid load 12 towards the sensor line 16.

The sensor line 16 is, in the preferred embodiment of this invention, a fibre optic line which, as is well known to those skilled in the art, can be adapted and used to detect, among other things, moisture, specific chemicals, changes in temperature, oil and natural gas. The present invention can also employ any other elongated sensor or array of sensors, including spaced gas, chemical oil, temperature and other sensors. More than one sensor line 16 can be provided.

By placing the sensor line 16 on top of the pipe 10, the sensor line 16 avoids contact with accumulated contaminants and debris which might accrete in the bottom of the skin 14, and ensures, thereby, that the sensor line 16 responds only to true leaks. As will become clear from the description of FIG. 11, other arrangements are possible within the scope of the present invention.

Attention is drawn to FIG. 2, showing the face of the skin 14 applied to the pipe 10. The reverse face of the skin 14 is smooth. The skin 14 comprises elastic ridges 18 which are wrapped circumferentially around the pipe 10 and held in place by a securing cover 20 which can be used to close the skin 14 by means of adhesives or other gripping means, and also serves to protect the sensor line 16 and to maintain it in position on top of the pipe 10.

Should a leak occur, the circumferential elastic ridges 18, against the face of the pipe 10, prevent the escaping fluid 12 from moving longitudinally along the pipe 10. Any fluid escape is ducted substantially circumferentially around the pipe at the location where it occurred. As is known in the art, a fibre optic sensor line 16 can detect the position along its length where interaction with a selected or detectable fluid has occurred. By confining the leaking fluid 12 to the point where the leak occurred, at least long enough for the escaping fluid to encounter the sensor line 16, and by sensing the position of interaction of the fibre optic sensor line 16 with the fluid, ducted towards the fibre optic sensor line 16, it is possible to obtain a very rapid detection of the fact that a leak has occurred and to find the position of that leak, with great accuracy. Distance along the fibre optic sensor line 16 is measured by finding the time delay for light travelling along the fibre optic sensor line 16.

The lower portion of FIG. 2 is a side view of the skin 14, looking in the direction of the arrow 22, showing the elastic ridges 18 in profile.

Attention is drawn to FIG. 3 showing one way in which the skin 14 of FIG. 1 can be attached to a pipe 10 (shown in phantom outline) by means of spaced bands 24 braced over the skin 14 at intervals along the pipe 10, not only to hold the skin 14 onto the pipe 10 but also to improve the ability of the skin 10 longitudinally to trap escaping fluid from the pipe 10. Couplings 26 allow the sensor line 16 to be coupled to sensor lines 16 on adjacent pipes 10. The arrangement shown in FIG. 3 constitutes a complete and portable pipe 10 unit which can be moved and installed as an entirety.

Attention is drawn to FIG. 4 showing another way in which a spiral skin 14A can be helically wrapped around the pipe 10 (shown in phantom outline).

FIG. 5 shows the arrangement of elastic ridges 18A on the spiral skin 14A. It is perceived that the elastic ridges 18A are longitudinal in the sense of direction of the spiral skin 14A, and when wrapped around the pipe 10 in a close fitting helical fashion, the elastic ridges 18A in the spiral skin 14A form a more or less vertical (circumferential) pattern which contains any leak in the vicinity of the sensor line 16. In the example shown in FIG. 4, the sensor line 16 is simply placed on top of the pipe 10 and the spiral skin 14A wrapped around the pipe 10. As will later be seen, better arrangements than this can be made. The elastic ridges 18, 18A can be provided at various angles to the longitudinal direction of the skin 14, dependently upon the intended manner of attachment thereof to the pipe 10.

The arrangement shown in FIG. 4 can further be improved by, in addition to helical wrapping, employing spaced bands 24 as illustrated in FIG. 3.

Attention is drawn to FIG. 6, showing, for clarity, a projected view of the cross section of FIG. 1, and showing, in particular, how the sensor line 16 is enclosed by and protected by the securing cover 20. The containment skin 14, shown in FIG. 6, is shown cut away to cover only a portion of the surface of the pipe 10 so that the disposition of the sensor line 16 can be seen. While the sensor line 16 is shown covered by the securing cover 20, it is to be understood that the skin 14 can be secured to the pipe 10 by other means and the sensor line 16 left uncovered by the skin 14 simply to have any escaping fluid 12 ducted in its direction.

Attention is drawn to FIG. 7 showing one way in which one or more sensor lines 16 can be threaded, permanently, through the material or fabric on the inside of the containment skin 14, otherwise shown in FIG. 2. If the inner face of the containment skin 14 contains any woven fabric element, the sensor line 16 can simply be woven into the fabric. Otherwise, the sensor line 16 can simply be moulded into or attached to the inner surface of the containment skin 14.

FIG. 8 shows a manner in which sensor lines 16 can be applied as an integral part of the spiral skin 14A shown in FIGS. 4 and 5. One or more sensor lines 16 are placed on the inner surface of the spiral skin 14A to run in the spaces between the elastic ridges 18A in the spiral skin 14A. They can be incorporated in just the same manner as was earlier described for FIG. 7.

Attention is next drawn to FIG. 9 showing an application of the present invention to a tank 28 containing a fluid. A tank skin 30 is wrapped around the tank 28, here shown wrapped in a spiral manner but other manners are possible, to cover the surface of the tank 28 as much as possible. The sensor line 16 leads all around the helical wrapping of the tank skin 30 and is accessible at either end via couplings 26A.

Attention is drawn to FIG. 10 showing the face of the tank skin 30 which faces the tank 28. Elastic ridges 18C form entire containment zones 32 in the centre of the tank skin 30 and partial containment zones 34 at the sides thereof and extending on either side, away from the entire containment zone 32 to the edge of the tank skin 30. When pressed against the tank 28, the entire containment zones 32 keep any escaping fluid, at least temporarily, from moving. The partial containment zones 34 co-operate with partial containment zones in adjacent wraps of the tank skin 30 to form at least a temporary containment area for escaping fluid. The sensor line 16, in the example shown, is provided only through the entire containment zone 32 and through one of the partial containment zones 34. As the tank skin 30 is wrapped, the sensor line 16 in the adjacent wrap of tank skin 30 acts to provide a sensor line 16 in a co-operation of partial containment zones where one is not present on the adjacent tank wrap 30. Since it is possible to measure the distance along the fibre optic sensor line 16, it is possible to measure where, on the surface of the tank 28 a leak has occurred. By knowing which portion of the tank 28 is covered by which portion of the tank skin 30, the location of a leak can be rapidly determined.

Attention is next drawn to FIG. 11, showing the cross sectional pipe arrangement of FIG. 1, but with a different arrangement for the relative position of the sensor line 16.

The sensor line 16 is, for preference, provided at the top of the pipe 10. However, as is clear if more than one sensor line is used, the sensor line 16 may be otherwise disposed on the pipe 10. FIG. 11 shows the sensor line 16 in a first position near the base of the pipe 10. The sensor line 16 is also shown in a second position where it is part way up the pipe 10. The sensor line can be attached, in varying positions on the pipe 10 by means of adhesives, tapes and spaced bands. All that is important is that the sensor line is in a position to interact with the escaping fluid 12, should an escape occur. The sensor line 16 can be longitudinally disposed along the pipe, or can be spirally wound around the pipe 10 in an arrangement incorporating the arrangement of the spiral skin 14A of FIG. 4 with an incorporated sensor lines 16 or lines 16 as shown in FIG. 7 and FIG. 8.

The elastic ridges 18 18A, shown in FIGS. 2, 5, 7, 8 and 10, can also be otherwise provided, according the present invention. The ridges 18 18A 18C may restrict the escaping fluid 12 from longitudinal migration along the pipe 10 However, localisation of the escaping fluid 12 is only necessary for enough time for the fluid 12 to reach the sensor line 16. Thus, arrangements of ridges 18 18A 18C, right down to there being no ridges 18, 18A 18B present, merely a conformal skin that spreads the escaping fluid across the surface of the pipe 10 at least as far as the sensor line, can also be provided and can work according the the present invention.

The skin 14 need not contain escaping fluid. The invention also functions if the fluid 12 can escape. The skin, in FIG. 11, shows a means of egress for the fluid, just to emphasize this point, where the securing cover 20 does not provide a fluid tight enclosure around the pipe 10.

Attention is drawn to FIG. 12 showing a projected schematic diagram illustrating how the present invention provides a control feature for tanks or pipelines.

An exemplary pipeline 36 comprises one or more pipeline sections 38 between pumping stations 40 through which a fluid is propelled as illustrated by arrows 42. The pipeline 36 could equally well be a tank.

A sensor line 16D is provided for leak detection on one or more adjacent pipeline or tank sections 38 and is driven and monitored by a sensor driver 44 which provides laser light, laser detectors, timers and all the other apparatus which, as is already known in the art, is necessary for the detection and location of a fluid leak. A monitor 46 receives output from the sensor driver 44 and displays the current state of the monitored pipeline 36 or tank. As soon as the monitor 46 detects that a leak has occurred, it sends an operating signal to a pump controller 48 which sends a control signal to each pumping station 40 on the monitored pipeline 38 or tank causing each pumping station 40 to shut down. The monitor 46 can then provide humanly interpretable input for assessing the progress of leak repair and recovery.

The pump controller 48 could equally receive its operating signal directly from the sensor driver. The operating signal for the pumping stations 40 can be provided to all pumping stations 40 on the monitored and controlled pipeline 36or tank, or can be provided only to that pumping station 40 or those pumping stations 40 which is or are nearest to and contain the loss of fluid from the leak. In this example, the pipeline 36 or tank is provided with pumping stations. The invention provides that a pipeline or tank can comprise pumping stations, stop valves, and, indeed, any device which can be applied or ceased to be used in order to shut down the loss of fluid flow from the pipeline 36 or tank whenever a leak is detected. This can comprise shutting down all flow. It can also comprises starting fluid movement out of the damaged section to prevent leakage loss, or a combination of both techniques. Thus, one pumping station 40 can be shut down in a pipeline 36 upstream of a leak and flow towards the leak stopped, while pumping downstream of the leak can be continued or enhanced to empty the pipeline 36. A monitored tank can have its inflow stopped while its outflow continues until the tank is empty, or until leakage stops as, for example, when the level in the lank falls below the height of the leak of until leakage is no longer detected.

The invention also provides that the sensor driver 44 can drive and monitor more than one sensor line 16D, either in the same pipeline (or tank) section 38 (where more than one indication of a leak can be employed to confirm a leak and prevent falsely indicated shutdowns) or in different pipeline (or tank) sections 38.

While it is implicit in the disclosure of the invention, it is here stated, for clarity, that the skin or skins 14 14A 30 can be flexible for wrapping around pipes, tanks and any other vessels to which the invention can be applied and that the invention, as described and claimed, can be retrofitted to existing pipes, tanks and other vessels.

The invention has so far been described by way of example. The invention is further described by the following claims.

1. An apparatus for determining the occasion and location of a fluid leak in a vessel, said apparatus comprising: a sensor line, on the outside of the vessel, for detecting where, along the length of the sensor line the sensor line is in contact with the fluid; and a skin, for use on the outside of the vessel and operative to direct leaked fluid towards the sensor line in the vicinity of any leak.

2. An apparatus, according to claim, wherein said skin is operative, at least temporarily, to contain fluid, leaked from the vessel.

3. An apparatus, according to claim 2, wherein said skin allows the escape of said fluid.

4. An apparatus, according to claims 1, 2 or 3, wherein said skin is operative to enclose both said vessel and said sensor line.

5. An apparatus, according to claims 1, 2, 3 or 4 for use where said vessel is a pipe, wherein said sensor line is disposable along the pipe

6. An apparatus, according to claim 5, wherein said skin comprises elastic ridges, to be pressed against the outer surface of the pipe and wherein said elastic ridges are operative to inhibit fluid flow in a longitudinal direction along the outside of the pipe and to directing fluid flow on the outside of the pipe towards said sensor line.

7. An apparatus, according to claim 5 or 6, wherein said skin is disposable longitudinally along the outside of the pipe and closable, longitudinally, by means of a securing over

8. An apparatus, according to claim 5 or 6, wherein said skin is helically wrappable about the pipe.

9. An apparatus according to claims 5, 6, 7 or 8, wherein said skin is further fixable onto the outside of the pipe by means of spaced bands.

10. An apparatus according to claims 1, 2, 3 or 4 for use where said vessel is a tank, wherein said sensor line is disposable on the outer surface of the tank.

11. An apparatus, according to claim 10, wherein said skin comprises elastic ridges, to be pressed against the outer surface of the tank, and wherein said elastic ridges are operative to form containment zones to at least temporarily contain fluid from any leak for the fluid to come into contact with said sensor line.

12. An apparatus, according to claims 10 or 11, wherein said skin is wrappable around the outside of the tank in a closed helix, wherein said skin comprises partial containment zones, and wherein a partial containment zone in one coil of the helix is co-operative with a partial containment zone in an adjacent coil of the helix to at least temporarily contain fluid from any leak for the fluid to come into contact with said sensor line.

13. An apparatus, according to any of the preceding claims, wherein said sensor line is incorporated into the fabric of the face of said skin which is for presentation to the outside surface of the vessel.

14. An apparatus, according to any of the preceding claims, wherein said sensor line is a fibre optic line.

15. An apparatus, according to any one of the preceding claims, including monitoring means, responsive to said sensor line to shut down said vessel in the event of detection of a leak.

16. An apparatus, according to claim 15, wherein said monitoring means is operative to cease pumping fluid at least into that portion of the vessel subject to the leak.

17. An apparatus, according to claims 15 or 16, wherein said monitoring means is operative to shut off at least that portion of the vessel subject to the leak.

18. An apparatus, according to any one of claims 15 to 17, wherein said monitoring means is operative to empty at least that portion of the vessel subject to the leak.

19. A method for determining the occasion and location of a fluid leak in a vessel, said method including the steps of: disposing a sensor line, on the outside of the vessel, for detecting where, along the length of the sensor line the sensor line is in contact with the fluid; disposing a skin on the outside of the vessel; and employing said skin to direct leaked fluid towards the sensor line in the vicinity of any leak.

20. A method, according to claim 19, including the step of employing said skin, at least temporarily, to contain fluid, leaked from the vessel.

21. A method according to claim 19, including the step of allowing the escape of said fluid.

22. A method, according to claims 19, 20 or 21, including the step of employing said skin to enclose both said vessel and said sensor line.

23. A method, according to any one of claims 19 to 22, where said vessel is a pipe, including the step of disposing said sensor line along the pipe.

24. A method, according to claim 23, including the steps of: employing elastic ridges on said skin; and pressing said elastic ridges against the outer surface of the pipe to inhibit fluid flow in a longitudinal direction along the outside of the pipe and to directing fluid flow on the outside of the pipe towards said sensor line.

25. A method, according to claims 23 or 24, including the steps of: disposing said skin longitudinally along the outside of the pipe; and closing said skin, longitudinally, by means of a securing cover

26. A method, according to claims 23 or 24, including the step of helically wrapping said skin about the pipe.

27. A method, according to any one of claims 23, 24, 25 or 26, including the step of fixing said skin onto the outside of the pipe by means of spaced bands.

28. A method, according to claims 19, 20, 21 or 22, where said vessel is a tank, said method including the steps of: disposing said sensor line on the outer surface of the tank.

29. A method, according to claim 28, including the steps of: employing elastic ridges on said skin; and pressing said elastic ridges against the outer surface of the tank to form containment zones to contain and accumulate fluid from any leak for the fluid to come into contact with said sensor line locally to the leak.

30. A method, according to claims 28 or 29, including the steps of: wrapping said skin around the outside of the tank in a close helix; and employing partial containment zones in said skin, a partial containment zone in one coil of the helix being co-operative with a partial containment zone in an adjacent coil of the helix to at least temporarily contain fluid from any leak for the fluid to come into contact with said sensor line locally to the leak.

31. A method, according to any one of claims 19 to 30, including the step of including said sensor line in the fabric of the face of said skin which is for presentation to the outside surface of the vessel.

32. A method, according to any one of claims 19 to 31, including the step of employing, in said sensor line, a fibre optic line.

33. A method, according to any one of claims 19 to 32, including the steps of monitoring said sensor line; and shutting down said vessel in the event of detection of a leak.

34. A method, according to claim 30, wherein said step of shutting down said vessel includes the step of ceasing to pump fluid at least into that portion of the vessel subject to the leak.

35. A method, according to claims 33 or 34, wherein said step of shutting down said vessel includes the step of shutting off at least that portion of the vessel subject to the leak.

36. A method, according to any one of claims 27 to 29, wherein said step of shutting down said vessel includes the step of emptying at least that portion of the vessel subject to the leak.
